(19) United States
(12) Patent Application Publication
(10) Pub. No.: US 2003/0065665 A1
(43) Pub. Date: Apr. 3, 2003

(54) Device, method and recording medium for information distribution

(75) Inventor: Naoto Kinjo, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/246,419

(22) Filed: Sep. 19, 2002

(30) Foreign Application Priority Data
Sep. 28, 2001 (JP) 2001-303524

(51) Int. Cl. G06F 7/00; G06F 15/16

(52) U.S. Cl. 707/10; 709/219; 709/218

(57) ABSTRACT

The object of the present invention is to provide a device, method, and a recording medium for information distribution, by which information desired by an individual customer is automatically provided to the individual customer without complicated works by the customer. Information distribution methods, kinds and fields of information desired to be distributed, times of the distribution, and configurations of devices for reproducing distribution information, which were assigned by customers at concluding contracts for information distribution, are previously stored as customer information, and, when time at which information of a specific kind and field is to be distributed to a specific customer has come, the pertinent information is retrieved, and is distributed to the customer by the assigned distribution method after image processing if required, and further retrieving related information if necessary. The distributed information is reproduced with the device assigned by the customer.

### BACKGROUND OF THE INVENTION

1. Field of the Invention

The present invention relates to a device, method and recording medium for information distribution, and, particularly, to the information distribution device for distributing information to customers, the information distribution method applicable for the above information distribution device, and the recording medium for recording programs by which a computer functions as the information distribution device.

2. Description of the Related Art

Recently, various kinds of pieces of contents information including images have been distributed to customers as information communication line networks such as the Internet have been widespread. As one example, a photonet (http://www.photonet.co.jp/) has provided services by which images which have been up-loaded by customers are saved in a Web server and users can browse the images on-line through cellular phones with a function for access to personal computers (PCs) or the Internet. And, an image distribution service according to an i mode (http://www.nttdocomo.co.jp/i/site.html/) has been known as one example of services by which images are distributed to cellular phones.

Generally, photographic prints photographed by users have been classified by user themselves to make photo albums, but classification of photographic prints and making photo albums are complicated works, and, at the same time, there are not so many opportunities to browse the made photo albums later, not balancing with complicated works. When the service of the photonet is used, the images may be browsed without complicated works such as classification of photographic prints and making photo albums, but there has been a problem that it takes much time to browse desired images as customers themselves are required to access the photonet and input ID information in order to browse own images which the Web server has saved.

Moreover, the image distribution service to cellular phones is a service by which images (still images or moving images) provided by associates are distributed, and it is not always guaranteed that the images which are desired by the customers to be distributed are included in the images that the associates provide. When the desired images are not included in the images provided by the associates, there has been a problem that it takes much time to acquire the desired images, as the customers themselves are required actively to look for the desired images.

The above-described problems have not been limited to a case in which contents information, which the customers desire is images, and it, is often that the desired contents information is not distributed in the distribution service even when contents information with another type such as voice and text information is desired. Moreover, there have been frequently generated situations in which complicated works such as ones for actively looking for the desired contents information are required.

### SUMMARY OF THE INVENTION

The present invention has been made considering the above-described circumstances. The object is to obtain a device, method, and a recording medium for information distribution, by which contents information desired by an individual customer can be automatically provided to the individual customer without complicated works by the customer.

In order to achieve the above-described object, a first aspect of the invention provides an information distribution device comprising: a selection component for selecting contents information to be distributed to a customer, based on information obtained from the customer; and a distribution component for distributing the contents information selected by the selection component to the customer through a predetermined communication component.

The selection component according to the first aspect of the invention selects for the customer the contents information to be distributed to the customer, based on information acquired from the customer. Here, the information acquired from the customer may be information which can be used for selection of the information to be distributed to the customer, for example, information, which has been acquired by assignment of the customer himself, representing the field or kind of the contents information to be distributed to the customer; information representing the contents of contents information which the customer has acquired or sent through another communication component; and information representing the contents of contents information by which the customer has selected for reproduction may be listed. Based on the information as described above, the selection component selects the contents information to be distributed to the customer.

Then, the distribution component according to the first aspect of the invention distributes contents information selected by the selection component to the customer through a predetermined communication component. Here, the contents information, which is selected by the selection component, and distributed to the customer by the distribution Component, may include at least one of, for example, a still image, a moving image, a voice, a text, and program. And, for example, a communication line network (Specifically, for example, the Internet), television broadcasting, and so on may be listed as a predetermined communication component. Moreover, the contents information distributed to the customer is reproduced by a reproduction component, which the customer has. For example, if the distributed contents information is a still image, a moving image, a text, and so on, the distributed information may be displayed on a display component (or, a device provided with a function for displaying images) such as a television, a PC, a cellular phone, a projector, and electronic paper (refer to the Japanese Patent Application National Publication (Laid-Open) No. 11-502950, and so on, and if the contents information is a voice, the information may be reproduced with a voice reproduction component (or, a device provided with a function for reproducing the voice) such as an audio device, and a cellular phone. Furthermore, if the distributed contents information is a program, the program may be executed with an information processing device (for example, a computer ouch as a PC, a PDA (personal digital assistance), and a portable device such as a cellular phone). For example, if the program is a gaming program, a gaming screen is displayed on the display component, and the customer may enjoy playing the game.

Thus, according to the first aspect of the invention, the probability that the contents information distributed to the customer is contents information which the customer desires to be distributed i& higher, comparing with a case in which contents information selected at random is distributed to a customer, as the contents information to be distributed to the customer is selected and automatically distributed to the customer, on the basis of information obtained from the customer. Accordingly, complicated works such as a work by which the customer actively looks for desired contents information, and a work for inputting IDs are not required to be done. Therefore, according to the first aspect of the invention, contents information desired by a customer can be automatically provided to the customer without complicated works by the customer.

It should be noted that the information distribution device pertaining to the first aspect of the invention may be structured so that the contents information is distributed only to a single customer (in this aspect, the information distribution device is placed in, for example, a house or the like or the customer to whom the contents information is to be distributed) or structured so that the contents information is respectively distributed to plural customers. When the contents information is to be distributed to plural customers, the information distribution device may be structured so that, for example, the selection component selects for each customer the contents information to be distributed on the basis of information obtained from each customer, and the distribution component distributes to each customer the contents information selected by the selection component. Thus, it is possible to automatically provide to each customer the contents information desired by each customer.

The selection component according to the first aspect of the invention selects for each customer the contents information to be distributed to the customers, based on information acquired from each customer. Here, the information acquired from each customer may be information which can be used for selection of the information to be distributed to the customers, for example, information, which has been acquired by assignment of the customers themselves, representing the field or kind of the contents information to be distributed to the customers; information representing the contents of contents information which the customers have acquired or sent through another communication component; and information representing the contents of contents information by which the customers have selected for reproduction may be listed. Based on the information as described above, the selection component selects the contents information to be distributed to the customer for each customer.

Then, the distribution component according to the first aspect of the invention distributes contents information selected by the selection component to each customer through a predetermined communication component. Here, the contents information, which is selected by the selection component, and distributed to the customers by the distribution component, may include at least one of, for example, a still image, a moving image, a voice, a text, and program. And, for example, a communication line network (specifically, for example, the Internet), television broadcasting, and so on may be listed as a predetermined communication component. Moreover, the contents information distributed to the customers is reproduced by a reproduction component, which the customers have. For example, if the distributed contents information is a still image, a moving image, a text, and so on, the distributed information may be displayed on a display component (or, a device provided with a function for displaying images) such as a television, a PC, a cellular phone, a projector, and electronic paper (refer to the Japanese Patent Application National Publication (Laid-Open) No. 11-502950, and so on, and if the contents information is a voice, the information may be reproduced with a voice reproduction component (or, a device provided with a function for reproducing the voice) such as an audio device, and a cellular phone. Furthermore, if the distributed contents information is a program, the program may be executed with an information processing device (for example, a computer such as a PC, a PDA (personal digital assistance), and a portable device such as a cellular phone). For example, if the program is a gaming program, a gaming screen is displayed on the display component, and the customers may enjoy playing the game.

Thus, according to the first aspect of the invention, the probability that the contents information distributed to each customer is contents information which each customer desires to be distributed is higher, comparing with a case in which contents information selected at random is distributed to an unspecified customer, as the contents information to be distributed to the customers is selected and automatically distributed to each customer. Accordingly, complicated works such as a work by which the customers actively look for desired contents information, and a work for inputting IDs are not required to be done. Therefore, according to the first aspect of the invention, contents information desired by the customers can be automatically provided to the customers without complicated works by the customers.

Here, in the first aspect of the invention, when the information distribution device further comprises a storage component for storing contents information, which can be distributed to customers, the selection component may select, for example, contents information to be distributed to the customer among pieces of contents information, which have been stored in the storage component. Still further, the contents information, which can be distributed to the customer, may be accumulated and stored, for example, in an information accumulation component which is a data base connected to the information distribution device according to the invention through a communication line. In this case, the selection component may have a configuration in which the contents information to be distributed to the customer is selected, for example, among pieces of contents information which have been accumulated and stored in the information accumulation component, and is acquired through the communication line.

Furthermore, contents information supplied from the customer (e.g., photographed image information obtained by the customer photographing an object, information of an image (also known as a CGI: Computer Generated Image) created by the customer using CG (Computer Graphics), image information obtained by the customer scanning and reading an image, audio information, and text information) may be stored in the storage component. In this case, the distribution component may have a configuration in which the contents information, which has been supplied from a specific customer and selected by the selection component, is distributed as the contents information to be distributed to the customer to at least one of the specific customer, and a distribution destination designated by the specific customer.

As distribution of contents information is automatically performed in the invention as described above, contents information supplied from the customer himself is automatically distributed, and contents information which the customer himself has supplied may be easily browsed and appreciated, by storing the contents information supplied by the customer himself in the storage component, without works in which the customer himself makes albums, or inputs IDs and so on in order to browse images and the like. In addition, as the contents information supplied by the specific customer is distributed to at least one of the specific customer and distribution destinations designated by the specific customer, the privacy of each customer may be protected.

Moreover, it is preferable in the first aspect of the invention that, for example, the field or the kind of contents information which is desired to be distributed, and at least one of time or cycle of the contents information distribution are designated by the customer in advance, and the selection component selects the contents information to be distributed to the customer, based on information representing the contents of the assignment obtained from the customer, so that the contents information is distributed to the customer according to the assignment by the customer.

When a customer desires contents information of a specific field or a specific kind to be distributed, the contents information of the assigned field or kind is distributed, if the field or the kind of contents information which the customer desires to be distributed is previously assigned: and the contents information is distributed at the designated time or cycle of the distribution, if the customer specifies the time or cycle of the contents information distribution in advance. Thereby, related images can be configured to be automatically distributed on a specific day, for example, when the image related with the specific day (for example, anniversary, and so on for the customer) is previously assigned by the customer so that the image is distributed on the specific day. Accordingly, information distribution in more agreement with the desire of the customer may be realized.

Still further, when, with regard to plural pieces of contents information desired to be distributed, the fields or the kinds are previously selected by the customer himself, respectively, and, at the same time, pieces of the times or the cycles of the distribution are designated for each field or each kind by the customer in advance, the selection component selects pieces of the contents information to be distributed for each field or each kind as one unit according to pieces of the times or the cycles of the distribution designated in advance; and the distribution component distributes the contents information selected by the selection component to the customer for each field or each kind as one unit. Thereby, even when pieces of the times or the cycles of the distribution that the customer desires are different from each other for each field or each kind of the contents information which the customer desires, contents information may be distributed at a time or cycle of distribution in agreement with that of the desire of the customer for each field or each kind of the contents information desired to be distributed.

Moreover, it is preferable in the first aspect of the invention that, when plural image information as contents information to be distributed to the customer is selected by the information distribution device according to the invention and distributed to a single customer, and a plurality of images represented by a plurality of distributed image information are displayed on a display surface of a single display component, for example, the distribution component distributes a plurality of image information after editing the plural pieces of information so that a plurality of images represented by a plurality of image information selected by the selection component are displayed on the display component of the customer in the display layout which has been previously assigned by the customer of the distribution destination.

Thereby, images represented by a plurality of distributed image information may be configured to be displayed on the displayed surface of the display component in the display layout in agreement with the desire of the customer, by making the customer assign the display layout (for example, display positions, and display size of individual images on the display surface of the display component). Here, when characters, and so on are included in the images represented by the image information, the size of the characters may be configured to be automatically changed according to the assignment of the customer, or according to the age, and so on of the customer.

Furthermore, it is preferable in the first aspect of the invention that the distribution component distributes, as the contents information to be distributed to the customer, the image information selected by the selection component after image processing corresponding to at least one of the attributes of the image information, the instruction from the customer of the distribution destination, and the configuration of the display component for display of images represented by the above image information. For example, the contents of the image represented by the image information may be listed as the attribute of the image information, and, for example, if the contents of the image is a landscape image, image processing such as processing by which shades, and so on of the image are corrected, according to the season, the weather, and the time zone (fine/cloudy/rainy/windy, or dawn/daytime/sunset) of the landscape represented by the image may be done as image processing according to the attribute of the image information.

Moreover, when execution of specific image processing is instructed from the customer of the distribution destination, the instructed image processing (for example, synthesis of characters and templates, synthesis of a voice, and so on) may be executed. Still further, conversion of the resolutions according to the configuration of the display component, conversion of the colors and the gradation, format conversion such as adjustment of the display size, and adjustment of the number of the gradation (number of bits per one pixel) which can be expressed, adjustment of number of frames for the image information representing the moving image, and so on may be listed as image processing according to the configuration of the display component. Thereby, images with the image quality and the image contents in agreement with the attribute of the image information, the tastes of the customer, and the configuration of the display component may be displayed on the display component of the customer.

In addition it is preferable in the first aspect of the invention that the selection component also selects contents information related with the contents information, which has been selected as the contents information to be distributed to the customer. The contents information related with the selected contents information may be information related with the attributes of the selected contents information (for example, information related with the photographing place, the object, the photographing date as the attributes of the above photographed image information, if it is photographed image information which has been obtained after the customer photographed an object.), or the selected contents information itself or the information related with the contents (for example, the information having the same or similar field or kind as or to that of the selected contents information, information explaining the contents of the selected contents information, and so on). Moreover, the related contents information may be a still-image, a moving image, a voice, a text, and so on, or information representing the reference of the main body of the contents information (for example, information on a link end of the Internet).

As the selection component selects the related information as described above, the related information may be distributed by the distribution component. Here, the distributed related information may be always provided to the customer, or may be displayed when there is an instruction from the customer. Thereby, even when the customer becomes interested in the distributed contents information, the related information may be much easily acquired, and the usefulness and entertaining performance of information distribution may be improved according to the contents of the distributed related information.

Still further, it may be configured in the first aspect of the invention that the selection component selects contents information related with the contents of the contents information which has been acquired, sent, or selected by the customer as the contents information to be distributed, based on at least one of the information which has been obtained from the customer, and represents the contents of the contents information which the customer acquires or sends through another communication component (for example, television broadcasting, information communication line networks such as the Internet, and a telephone), and the information representing the contents of the contents information which the customer has selected for reproduction. Thereby, the field, and so on in which the customer is interested may be automatically discriminated from the contents of the contents information which is acquired or sent through another communication component, or, from the contents of the contents information which the customer has selected for reproduction, and, the contents information on the field, and so on in which the customer is interested can be provided in a well-timed manner. Accordingly, the usefulness and the entertaining performance of information distribution may be improved.

In addition, it is preferable that the selection component determines a tendency of the tastes of the customer from the information acquired from the customer; and the contents information in agreement with the tendency of the tastes of the customer is selected as the related contents information. Thereby, the contents information in more agreement with the desire of the customer may be distributed as the related contents information.

And, in the first aspect of the invention, the distribution component may execute distribution through a communication line network (for example, the Internet), or television broadcasting as the predetermined communication component. Moreover, in the case of distribution through television broadcasting, the distribution component may be configured to add to the distribution information the customer ID that is used for identifying the distribution destination of the information at the side of the customer. In this case, the contents information selected for each individual customer may be distributed to the individual customer by a configuration in which the receiving side of the distribution information (the customer side) receives only the distribution information to the own station, based on the customer ID added to the distribution information.

A second aspect of the invention provides an information distribution method comprising the steps of: selecting contents information to be distributed to a customer, based on information obtained from the customer; and distributing the selected contents information to the customer through a predetermined communication component. Accordingly, as well as the first aspect of the invention, the contents information desired by the customer can be automatically provided to the customer without complicated works by the customer.

A third aspect of the invention provides a recording medium in which a program executed by a computer is recorded, the program comprising the steps of: selecting contents information to be distributed to a customer, based on information obtained from the customer; and distributing the selected contents information to the customer through a predetermined communication component.

The recording medium according to the third aspect of the invention records the program for processing including the above-described first and second steps, that is, the program by which the computer functions as the information distribution device according to the first aspect of the invention. Accordingly, as well as the first aspect of the invention, the contents information desired by the customer can be automatically provided to the customer without complicated works by the customer, as the computer reads and executes the program recorded in the recording medium.

As described above, the first and second aspects of the invention have an excellent advantage that contents information which the customer desires can be automatically provided to the customer without complicated works by the customer, as contents information to be distributed to the customer is selected for the customer, based on the information acquired from the customer, and the selected contents information is distributed to the customer through a predetermined communication component.

The invention of the first aspect has, in addition to the aforementioned effect, another effect in that contents information that individual customers desire can be automatically supplied to the individual customers by selecting for each customer, on the basis of information obtained from the individual customers, contents information to be distributed to the customers and distributing to each customer the selected contents information.

The first aspect of the invention has another advantage, in addition to the above advantage, that contents information that the customer has supplied may be easily browsed and appreciated by the customer himself, and the privacy of each customer may be also protected, as, the contents information that has been supplied from the customer is stored in the storage component for storing the contents information which can be distributed to the customer, and the contents information supplied from a specific customer is distributed to at least one of the specific customer and distribution destination designated by the specific customer.

The first aspect of the invention has another advantage, in addition to the above advantages, that information in more agreement with the desire of the customer may be distributed, as the field or the kind of contents information which is desired to be distributed, and at least one of time or cycle of the contents information distribution are designated by the customer in advance, and the contents information to be distributed to the customer is selected so that the contents information is distributed to the customer according to the assignment by the customer.

Moreover, there is another advantage, in addition to the above advantages, that, even when pieces of the times or the cycles of the distribution that the customer desires are different from each other for each field or each kind of the contents information which the customer desires, contents information may be distributed at a time or cycle of distribution in agreement with that of the desire of the customer for each field or each kind of the contents information desired to be distributed, as pieces of the contents information to be distributed to the customer are selected for each field or each kind as one unit according to the time or the cycle of the distribution designated in advance, and the selected information is distributed to the customer for each field or each kind as one unit.

The first aspect of the invention has another advantage, in addition to the above advantages, that images represented by a plural pieces of image information are displayed on the display component of the customer in a display layout in agreement with the desire of the customer, as plural pieces of image information which have been selected for distribution to the customer are distributed after edition so that a plurality of images represented by the plural pieces of image information are displayed on the display component of the customer in a display layout which has been previously assigned by the customer of the distribution destination.

The first aspect of the invention has another advantage, in addition to the above advantages, that images with the image quality and the image contents in agreement with the attribute of the image information, the tastes of the customer, and the configuration of the display component may be displayed on the display component of the customer, as the selected image information is distributed after the selected image information undergoes image processing corresponding to at least one of the attributes of the image information, the instruction from the customer of the distribution destination, and the configuration of the display component for display of images represented by the above image information.

The first aspect of the invention has further another advantage, in addition to the above advantages, that the usefulness, and the entertaining performance of the information distribution may be improved, as the contents information related with the contents information which has been selected as the contents information to be distributed to the customer is also selected.

The first aspect of the invention has another advantage, in addition to the above advantages, that the usefulness, and the entertaining performance of the information distribution may be improved, as information related with the contents of the contents information which the customer acquires or sends through another communication component, or one related with the contents of the contents information which the customer has selected for reproduction.

Furthermore, there is another advantage, in addition to the above advantages, that the information in more agreement with the tendency of the tastes of the customer may be distributed, as the tendency of the tastes of the customer is determined from the information acquired from the customer, and the contents information in agreement with the tendency of the tastes of the customer is selected as the related contents information.

The third aspect of the invention has an excellent advantage that the contents information which the customer desires can be automatically provided to the customer without complicated works by the customer, as the recording medium stores a program by which a computer executes processing comprising the steps of: selecting contents information to be distributed to a customer, based on information obtained from the customer; and distributing the selected contents information to the customer through a predetermined communication component.

### BRIEF DESCRIPTION OF THE DRAWINGS

FIG. 1 is a block diagram showing a schematic configuration of an information distribution system according to a first embodiment.

FIG. 2 is an image view showing one example of a display layout.

FIG. 3A is a flow chart showing the contents of information distribution processing.

FIG. 3B is a flow chart showing the contents of another information distribution processing.

FIG. 4 is a block diagram showing a schematic configuration of an information distribution system according to a second embodiment.

### DESCRIPTION OF THE PREFERRED EMBODIMENTS

Hereinafter, embodiments of the present invention will be described in detail, referring to drawings.

### The First Embodiment

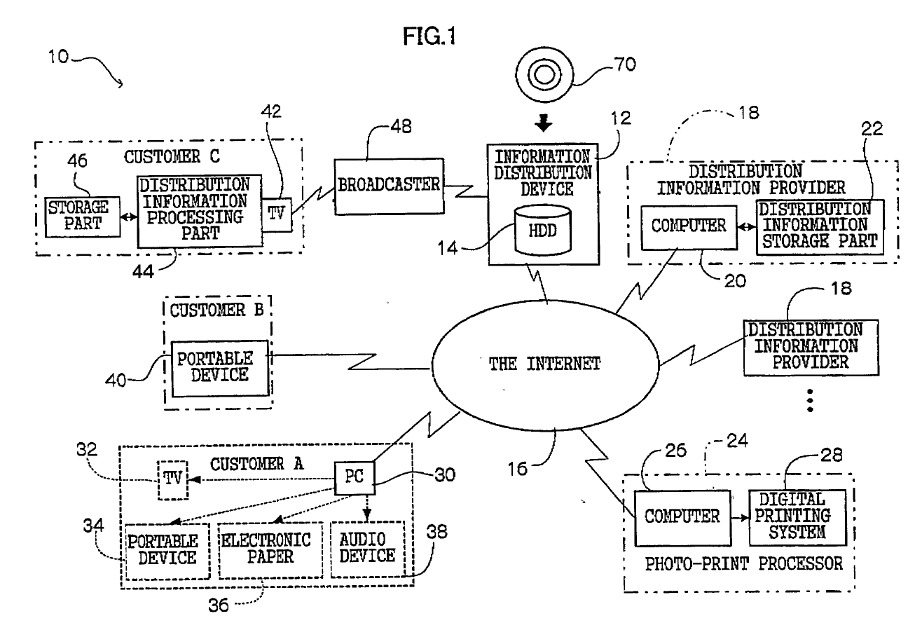

FIG. 1 shows an information distribution system 10 according to the present first embodiment. The information distribution system 10 is provided with an information distribution device 12. The information distribution device 12 has a configuration in which it comprises a computer such as a work station; a CPU (central processing unit), a ROM (read-only memory), a RAM (random access memory) and an input/output port are connected to each other through a bus, though not shown; and displays such as a CRT (cathode ray tube), and an LCD (liquid crystal display), a mouse, a keyboard, a hard disk drive (HDD) 14 (refer to FIG. 1), CD-ROM (compact disc read-only memory) disk drive, a communication control device (for example, a modem or a router), and so on are connected to the input/output port as various kinds of input-output devices, respectively.

An information distribution program has been previously installed in the HDD 14 of the information distribution device 12, and information distribution processing (the detail will be described later) to which the information distribution method according to the invention is applied is executed by the CPU in the information distribution device 12 according to the information distribution program. Moreover, a computer forming the information distribution device 12 functions as the information distribution device according to the invention, as the CPU executes the information distribution program. The information distribution program is previously stored in, for example, a CD-ROM 70 (refer to FIG. 1). Then, the above program may be installed by setting the above CD-ROM 70 in the CD-ROM disk drive of the information distribution device 12, and by instruction to import (install) the above program from the CD-ROM 70 into the information distribution device 12.

Thus, the CD-ROM 70 storing the information distribution program corresponds to the recording medium of the first aspect of the invention. Here, other recording media such as a floppy disk, an HO (magneto optical disk), a ZIP, and a DVD (digital video disk) may be used instead of the CD-ROM 70. The program recorded on the recording medium may be downloaded and installed in the computer via a computer network such as the Internet.

The information distribution device 12 provides a service by which pieces of information which are desired by the customers to be distributed (or pieces of information which are presumed to be desired to be distributed by customers) are distributed in a distribution method which the customers have assigned, to the customers who have previously concluded a contract for information distribution with an information distribution agency having the information distribution device 12 (details will be described later). Therefore, pieces of information (pieces of customer information) on individual customers who have concluded contracts for information distribution are stored in the HDD 14, and, at the same time, various kinds of information (corresponding to the contents information pertaining to the invention), which can be distributed to the customers, may be also stored. Here, for example, still image information representing still images, moving image information representing moving images, voice information, text information, and so on may be listed as the kinds of information which can be distributed to the customers, and the various kinds of pieces of information as described above are stored for various kinds of fields. still more, for example, landscapes (for example, landscapes such as famous places of natural beauty and historical interest), figures (for example, talented persons), pictures, calendars, weather forecasts (may be weather forecasts around the distribution destinations, or those for areas which have been previously assigned), and so on may be listed as a field of the still image; for example, movies and animated cartoons, sports pictures, a clock, (may be a moving image of a digital clock, or that of an analogue one) and so on are done as a field of the moving image; for example, background music and time signals, pieces of music which have been previously determined for each time, and so on may be listed as a voice field, and for example, news and regional information, and so on may be listed as a text field, but the fields are not limited to the above.

Moreover, the information distribution system 10 according to the present embodiment has a configuration in which the customers have photographed objects to obtain pieces of photographed image information; the customers can upload the information to the information distribution device 12; and pieces of the photographed image information uploaded from the customers to the information distribution device 12 are also stored (saved) in the HDD 14. Thus, the HDD 14 corresponds to the storage component of the first aspect of the invention.

Moreover, (the communication control device of) the information distribution device 12 is connected to the Internet 16, and computers 20 (for example, personal computers (PCs), and so on), which a plurality of distribution information providers 18 have, respectively, are connected to the Internet 16, and, at the same time, computers 26 (for example, PCs, and so on) which photo-print processors 24 have are also connected thereto. Furthermore, other computer networks constructed with high-speed, mass dedicated communication lines, instead of the Internet 16, may be used.

A distribution information storage part 22 for storing pieces of information, which can be distributed to the customers, is connected to the computers 20 of the distribution information providers. Furthermore, the photo-print processors 24 have a digital printing system 28 comprising a film scanner reading images recorded on photograph films, a digital printer for photo-print processing by which images represented by image data are recorded on recording materials such as photographic papers, and so on. The digital printing system 28 is connected to one of the computers 26, and photo-print processing may be realized, using image data received by the computers 26 through the Internet 16.

The customers who have concluded contracts for information distribution with the information distribution agency have an information reproduction device, respectively, for reproducing the information distributed from the information distribution device 12, but the kinds, and so on of the information reproduction devices which the individual customers have are not the same. Therefore, as a method by which information is distributed from the information distribution device 12 to the customers in the present first embodiment, some distribution methods are prepared, according to the kinds, and so on of the information reproduction devices which the customers have, for a method by which information is distributed from the information distribution device 12 to the customers.

Typical information reproduction devices which the customers have are, as denoted by “CUSTOMER A” in FIG. 1, a PC 30 (another information processing device may be acceptable) which has a function for connection to the Internet 16. Moreover, in some cases, devices (for example, at least one of a TV 32 shown in FIG. 1 with a dotted line, a portable device 34 (a cellular phone, a personal handy system (PHS), and a PDA, and so on), electronic paper 36, and an audio devices 38) for reproducing information which the PCs 30 have received from the information distribution device 12 through the Internet 16 are connected to the PCs 30. When the object customer to whom information is distributed has the above-described information reproduction devices, the information distribution device 12 distributes the information to the PC 30 of the customer through the Internet 16.

Here, the electronic paper 36 is a display device (for example, refer to the Japanese Patent Application National Publication (Laid-Open) No. 11-502950, Nikkei Electronics Dec. 4, 2000 (No. 784), p. 40, and so on) which is extremely thin and flexible, and can display arbitrary information, using an electrophoretic phenomenon, and so on, but it is needless to say that an ordinary liquid crystal display (LCD), instead of the above device, may be used.

Moreover, there is a case, as denoted by “CUSTOMER B” in FIG. 1, in which only the portable device 40 with a function for connection to the Internet 16 is provided as an information reproduction device, depending on customers. When the object customer for information distribution has only the portable device 40, the information distribution device 12 distributes information to the portable device 40 of the customer through the Internet 16 after the information to be distributed is processed to information suitable for being distributed to the portable device 40.

Furthermore, there is also a customer, as denoted by “CUSTOMER C” in FIG. 1, who has, as an information reproduction device, a TV 42 to which a distribution information processing part 44, and a memory part 46 are connected. When the object customer for information distribution has the TV 42 with the above-described configuration, the information distribution device 12 distributes information to the TV 42 of the customer by asking a broadcaster 48 to distribute the information after the information to be distributed is processed to information suitable for being distributed to the TV 42.

Then, the operations of the present first embodiment will be described. When the customer concludes a contract for information distribution with the information distribution agency, information on the distribution method of the information, the kind and field of the information which is desired to be distributed, the times (the date or cycle) of the information distribution, the configuration of the information reproduction device for reproducing the distributed information, and so on is notified to the information distribution agency. The information distribution agency gives a customer ID to the individual customer who has concluded the contract for information distribution with the agency, and, at the same time, the customer information shown in the following Table 1 as one example is registered in the HDD 14 of the information distribution device 12, based on the information notified from the customer.

TABLE 1
<One example of customer information (one record)>

| Item | | Contents |
|---|---|---|
| Customer ID | | XXXXX |
| Information distribution method | | Ex. Internet |
| Specific information on distribution | | . . . |
| Configurations of all the information | | . . . |
| reproduction devices | | |
| Image display layout | | . . . |
| Distribution | Kind and field | Ex. Landscape image |
| information | Time of Distribution | Ex. N time cycle |
| A | Information reproduction | Ex. Electronic paper and |
| | device to be used | portable device |
| | Other attributes | Ex. Addition of |
| | | description note |
| | Distribution history | Information ID, and |
| | | distribution date |
| | Other distribution | . . . |
| . | . | . |
| . | . | . |
| . | . | . |

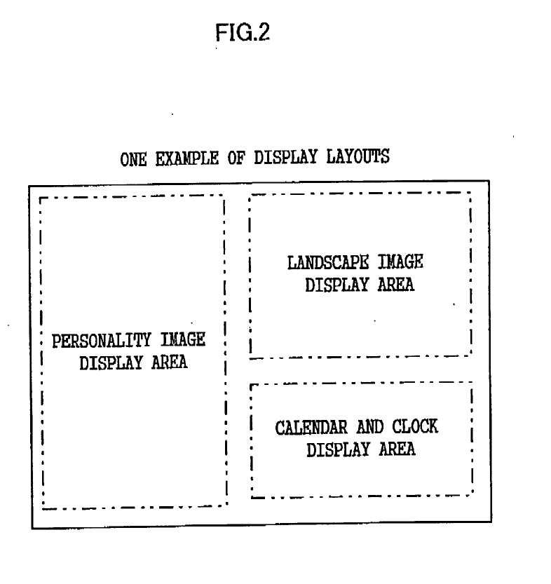

The customer information shown in Table 1 shows one example of the customer information (one example of the customer information for one record corresponding to a single customer), and, as attribute information on an individual customer, a customer ID is set for “CUSTOMER ID”, information defining a distribution method when information is distributed to the customer is done for “INFORMATION DELIVERY METHOD”, and information for specifying a distribution destination (for example, an IP address of the PC 30, a terminal number of the portable device 40 of the customer, and so on) is done for “SPECIFIC INFORMATION ON DELIVERY END”, respectively. Moreover, information representing respective configurations (kinds/formats of information which can be reproduced/reproduction performances (for example, display resolution, gradation, color gamut, and so on of an image display device for reproducing and displaying images) of all the information reproduction devices (all the information reproduction devices which can be used for reproducing the distributed information) which the customers have is set for “CONFIGURATIONS OF ALL THE INFORMATION REPRODUCTION DEVICES”, and information defining display layouts (one example is shown in FIG. 2) when a plurality of pieces of information are reproduced and displayed on a single image display device is done for “IMAGE DISPLAY LAYOUT”, respectively.

Furthermore, pieces of information of six items which are denoted by “DELIVERY INFORMATION A” in table 1 are pieces of attribute information corresponding to a single distribution information (individual information which the customers desire to distribute); the same number of records as that of pieces of distribution information which the customers assign are provided, assuming that one record includes the above-described six items; and pieces of attribute information are set in each record corresponding to assignments of the customers.

With regard to the attribute information set in each item, in more detail, the kind (still image/moving image/voice/text . . . ), and the field (for example, what kind of image it is in the case of an image, and so on.) of the distribution information are set for “KIND AND FIELD”, and the cycle or the date of the information distribution are done for “TIME OF THE DISTRIBUTION”, respectively. Moreover, in the present embodiment, IDs are added, respectively, to all pieces of information, which can be distributed to the customers to identify individual information, and the ID of the specific information is set for “KIND AND FIELD” when the customers desire a specific piece of information to be distributed on a specific date.

In addition, information defining an information reproduction device to be used for reproducing the corresponding distribution information, among each information reproduction device the configuration of which is defined in the above-described “CONFIGURATIONS OF ALL THE INFORMATION REPRODUCTION DEVICES” is set for “INFORMATION REPRODUCTION DEVICE TO BE USED”, and other pieces of attribute information on distribution information are set for “OTHER ATTRIBUTES”, respectively (as one example, an example in which it is set as attribute information that a description note has been assigned by the customer to be added to a landscape image as the pertinent information is shown in Table 1). And, IDs, and distribution dates of pieces of the information, which have been distributed as the pertinent information in the past, are automatically set for “DELIVERY HISTORY” by the information distribution device 12. In addition, information required to distribute information to specific distribution destinations (customer IDs, distribution methods, pieces of information for specifying the distribution destinations, and so on) is set for “OTHER DISTRIBUTION DESTINATIONS”, when the customer desires the pertinent information to be distributed to the other specific distribution destinations.

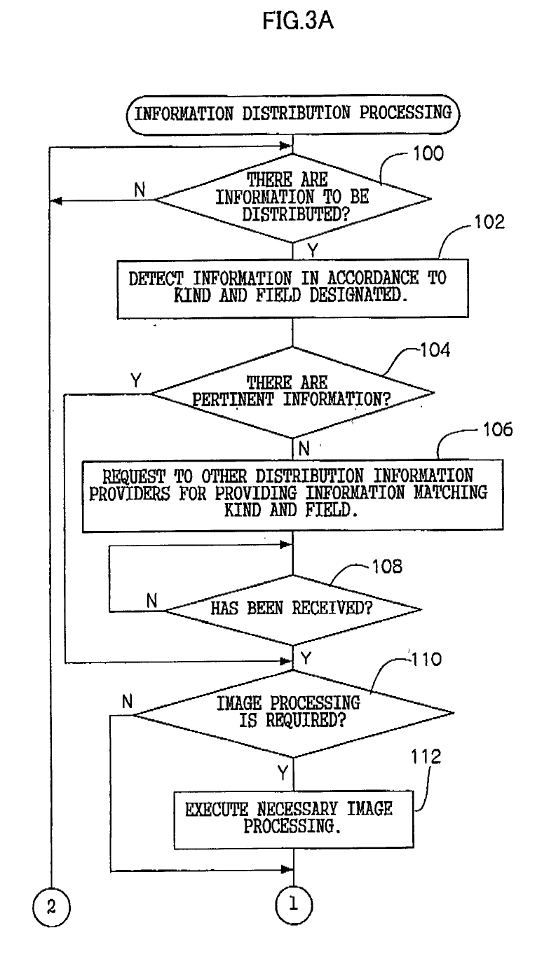

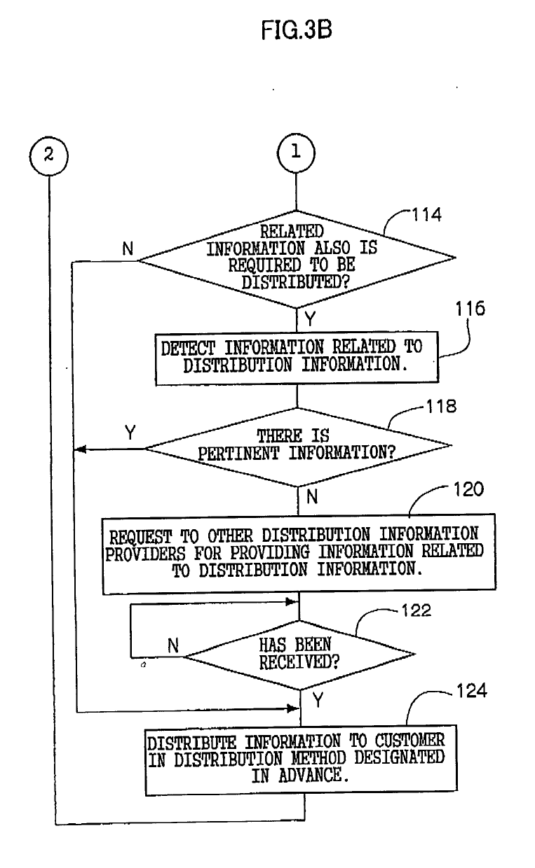

Then, the information distribution processing, which is always executed by the information distribution device 12, will be described, referring to a flow chart in FIGS. 3A and 3B. At a step 100, the customer information on individual customers which has been stored in the HDD 14 are sequentially referred, letting one set of pieces of attribute information of individual distribution information be one unit, and it is decided whether there are pieces of distribution information which have time due to be distributed to customers. When the determination is negative, the step 100 is repeated till the determination is affirmative.

For example, when there is found distribution information with regard to which time equivalent to the distribution cycle which has been set in “DELIVERY TIMING” has elapsed referring to the previous information distribution date set in “DELIVERY HISTORY” is found, or when there is found distribution information with regard to which the distribution date which has been set in “DELIVERY TIMING” has come, the determination at the step 100 is affirmative, the processing proceeds to a step 102, and it is retrieved whether information which is in accordance with the conditions set in “KIND AND FIELD” is stored in the HDD 14.

Specifically, when the ID of the distribution information has been set in “KIND AND FIELD”, information specified by the above ID (for example, specific photographed image information) is retrieved, and, when the kind and field of the information to be distributed has been set in “KIND AND FIELD”, information in accordance with the kind and field which has been set (information suitable for distribution) is retrieved. Moreover, when information in accordance with the kind and field which has been set is retrieved, information distributed in the past may be excluded (not distributed) from the objets to be retrieved, based on the IDs, which have been set in “DELIVERY HISTORY”, of information distributed in the past, and, when the distribution frequency is equal to or smaller than a predetermined value even if the information is information distributed in the past, the information may be included in the objects to be retrieved (it is distributed if there is no information suitable as objects to be distributed other than the information).

At the next step 104, it is decided whether the pertinent information has been found by retrieving at the step 102. When the determination is affirmative, the found information is read out from the HDD 14, and the processing proceeds to a step 110, and when the determination is negative, the processing proceeds to a step 106, at which conditions for retrieving of the distribution information (for example, “KIND AND FIELD”, and “DELIVERY HISTORY” of the distribution information) is notified through the Internet 16 to other distribution information providers 18, and the information in accordance with the conditions is requested to be provided. At a step 108, a waiting state is kept till the information is received from the distribution information providers 18. The distribution information providers 18 who are requested retrieve whether information in accordance with the notified conditions for retrieving has been stored in the distribution information storage part 22, and the information extracted by retrieving is transmitted to the information distribution device 12. The determination at the step 108 is affirmative by receiving the above information, and the processing proceeds to the step 110.

When the amount of information which can be stored in the HDD 14 of the information distribution device 12, and information suitable for distribution has not been stored in the HDD 14, the information is provided from the other distribution information providers 18 by requesting the other distribution information providers 18 to provide the information as described above. Accordingly, various kinds of information can be distributed to the customers.

Here, the information may be provided from a plurality of the distribution information providers 18, though a case, in which the information has been provided from a single distribution information provider 18, has been shown at the above-described steps 106, 108 in order to make the description simple. In this case, it is configured that the requesting order of the information to be provided is defined beforehand, (the order maybe defined in a fixed manner. or it may be done for each kind or each field of the information), in the first place, the distribution information provider 18 with the highest position in the order is requested to provide the information, and the distribution information provider 18 with the lower position in the order may be requested to provide the information when the distribution information provider 18 with the highest position has not had information suitable for distribution; and a plurality of distribution information providers 18 is requested, respectively, for notification of information which the providers can provide, information best for distribution information is selected, based on a list, and so on of respective pieces of information, which have been notified as providable pieces of information from each distribution information provider 18, and a distribution information provider 18 having the selected information may be requested to provide the information.

Here, the above-described steps 100 to 108 are corresponding to the selection component of the invention (in detail, the selection component according to the first aspect of the invention).

At the step 110, it is decided whether any image processing is required for the distribution information, which has been obtained by reading out from the HDD 14, or by receiving it from the distribution information provider 18. The determination unconditionally is negative when the acquired distribution information is not image information, and the processing proceeds to a step 114.

On the other hand, for example, when the acquired distribution information (image information) is not suitable for reproduction and display on the information reproduction device set in “INFORMATION REPRODUCTION DEVICE TO BE USED” (disagreement in, for example, the information format (for example, jpeg, gif, png, and bmp), the display resolution, the gradation, and the color gamut), the determination at the step 110 is affirmative, and the proceeding proceeds to a step 112, at which image processing for converting the acquired distribution information into information suitable for reproduction and display on the information reproduction device to be used is executed as necessary image processing. Here, a plurality of information reproduction devices are set as “INFORMATION REPRODUCTION DEVICE TO BE USED” as shown in Table 1 as one example, and the acquired distribution information is converted into plural kinds of pieces of distribution information corresponding to respective information reproduction devices at the step 112, when there is disagreement in the information format, the display resolution, the gradation, the color gamut, and so on which can be reproduced on respective information reproduction devices).

Moreover, for example, even when a frame size of the image represented by the acquired distribution information (image information) is not in agreement with that of a display area defined by the information set in “IMAGE DISPLAY LAYOUT” the determination at the step 110 also is affirmative, and the processing proceeds to the step 112, at which image processing by which the frame size of the image represented by the acquired distribution information is enlarged or reduced according to the frame size of the display area is performed as necessary image processing.

In addition, even when it is set for “OTHER ATTRIBUTES” as attribute information as shown in Table 1 as one example that execution of a specific image processing is instructed by the customers, the determination at the step 110 also is affirmative, and the processing proceeds to the step 112, at which the image processing instructed by the customers (addition of a description note (text) to the landscape image in the example of Table 1) is performed.

Furthermore, the image processing may be selectively processed according to the attributes of the acquired image information to be distributed. For example, if the image information to be distributed is a photographed image information up-loaded by the customer of the distribution destination, image processing corresponding to the contents of the image represented by the photographed image information may be performed. If the image is a landscape image in which a landscape is an object, image processing such as processing by which shades, and so on of the image are corrected, for example, according to the season, the weather, and the time zone (fine/cloudy/rainy/windy, or dawn/daytime/sunset) of the landscape represented by the image may be listed as image processing according to the contents of the image, and, if the image is a portrait image in which a person is an object, image processing such as processing by which the sharpness of the image is slightly reduced, and the image is changed to an image with image quality having the same quality as that obtained by soft-focus photographing may be listed.

And, one kind of image processing may be uniformly applied, regardless of attributes, and so on of the image information to be distributed, to pieces of image information to be distributed (for example, image processing by which images are changed into those with a style of oil painting/that of watercolor/that of India ink painting/that of animation, image processing by which specific characters are synthesized, and so on).

Moreover, at the step 112, predetermined processing may be performed according to the information reproduction device to be used for reproduction even when pieces of information other than the image information are objects to be distributed. For example, when voice information is an object to be distributed, processing such as change in number of channels (monaural/stereo/quadraphonic/5.1 channel (a surround-sound system)), and equalizing may be configured to be performed according to a device to be used for voice reproduction. Here, the above steps 110, 112 correspond to the distribution component of the first aspect of the invention.

At the next step 114, it is decided whether information related with the distribution information is to be distributed or not. Moreover, when the distribution information is a landscape image, for example, a text describing the object (famous places of natural beauty and historical interests, and so on) a text showing the photographing date, the photographing conditions, and so on, a map showing a place of the object, and the photographing place, a text showing a URL of a web site on which participation in a tour to visit the place of the object can be applied for and so on may be listed as the related information. In addition, when the distribution information is a movie (moving image), for example, a name of a director, names of actors and actresses, a text publicizing the opening date, a text publicizing the description note of the movie, an image showing an advertising poster for opening, a text or an image publicizing other movies having the same director and the same actors and actresses and other movies having the same genre, and so on, a text showing a URL of a Web site on which video tapes and DVDs, in which the movie to be distributed is recorded, can be purchased, or others may be listed as the related information. Furthermore, when the distribution information is music, for example, players, lyric writers, and composers, a text publicizing the recording date, a text publicizing titles of other pieces of music which have the same players, the same lyric writers, and the same composer, a text showing a URL of the Web site on which CDs recording pieces of music to be distributed can be purchased, and so on may be listed as the related information.

It may be configured that pieces of the above related information are uniformly added to all pieces of distribution information; it is settled, when contracts for distributing information are previously concluded with customers, whether pieces of the related information are distributed; and pieces of the related information are distributed through the Internet 16 only when distribution of pieces of the related information is requested by customers. When the related information is not distributed, the determination at the step 114 is negative, and the processing proceeds to a step 124, but, when the related information is distributed, the determination at the step 114 is affirmative, and the processing proceeds to a step 116, at which it is retrieved whether the information which can be distributed as related information is stored in the HDD 14.

At a step 118, it is decided by retrieving at the step 116 whether the pertinent information has been found or not. When the determination is affirmative, the found information is read from the HDD 14, and the processing proceeds to the step 124. On the other hand, when the determination is negative, the processing proceeds to a step 120, at which the Its, and so on of pieces of the distribution information are notified to other distribution information providers 18 through the Internet 16, and pieces of information related with the distribution information are requested to be provided. Then, at a step 122, a waiting state is kept till the related information is received from the distribution information providers 18. Here, the above steps 114 to 122 correspond to the selection component of the first aspect.

The distribution information providers 18 who are requested retrieve whether the information related with the information (distribution information) with the notified IDs has been stored in the distribution information storage part 22, and the information extracted by retrieving is transmitted to the information distribution device 12. When the information is received, the determination at the step 122 is affirmative, and the processing proceeds to the step 124.

And, at the step 124, the distribution information (and, the related information) is distributed to a customer specified with “CUSTOMER ID” by a distribution method (distribution through the Internet 16, or through the broadcaster 48) defined by the information set in “INFORMATION DELIVERY METHOD” (moreover, when any information is set in “OTHER DELIVERY ENDS”, distribution is also made to a distribution destination specified by the above information). Then, the processing is returned to the step 100 after updating “DELIVERY HISTORY” of the customer information, and, steps after the step 100 (including) are repeated. Here, the above step 124 corresponds to the distribution component of the invention (in more detail, the distribution component of the first aspect of the invention).

Here, the above-described distribution of information is realized as follows: Specifically, for example, when a customer of a distribution destination has the PC 30 with a function for connection to the Internet 16 as denoted by “CUSTOMER A” in FIG. 1, or, for example, when a customer of a distribution destination has the portable device 40 with a function for connection to the Internet 16 as denoted by “CUSTOMER B” in FIG. 1, distribution of information through the Internet 16 is done, for example, by assigning an address (for example, the IP address of the PC 30 or the terminal number of the portable device 40) of an information receiving terminal (the PC 30 or the portable device 40) of the customer, and by transmitting the information, and the information is received with the information receiving terminal after procedures such as authentication to realize the distribution. Then, the distributed information is stored for a while in a storage component (HDD, a memory, and so on) built in the PC 30 or the portable device 40 of the customer.

Moreover, when the information reproduction devices such as the TV 32, the portable device 34, the electronic paper 36, and the audio devices 38 are connected to the PC 30, and the information reproduction devices, other than the PC 30, are assigned by the customer as an information reproduction device used for reproducing the information (when information defining that the information reproduction devices other than the PC 30 are used is set for “INFORMATION REPRODUCTION DEVICE TO BE USED” of the customer information) the information which has been stored for a while in the storage component built in the PC 30 is distributed to the pertinent information reproduction device again, using the above-described information receiving software. Then, the distributed information is configured to be reproduced in an automatic manner or based on the instruction from the customer as start by the information reproduction device assigned by the customer.

And, for example, when a customer of a distribution destination has the TV 42 to which the distribution information processing part 44 and the storage part 46 are connected as denoted by “CUSTOMER C” in FIG. 1, the broadcaster 48 is asked to distribute the information by adding a customer ID to the information to be distributed (another information for specifying a distribution destination, instead of the customer ID, may be used), and by transmitting it to the broadcaster 48. Here, the information may be transmitted to the broadcaster 48 after encoding. The broadcaster 48 who is asked to distribute the information modulates the information received from the information distribution device 12 to a distribution signal, and broadcasts the distribution signal as a signal of a specific channel, or does so superimposing the distribution signal on an ordinary TV broadcasting signal.

The distribution information processing part 44 connected to the TV 42 receives a modulated signal broadcast as a signal of a specific channel, or monitors whether the distribution signal is superimposed on the TV broadcasting signal, which the TV 42 has received, and, when the distribution signal is superimposed on the TV broadcasting signal, the distribution signal is extracted. Then, the customer ID added to the received or extracted distribution signal is compared with the customer ID which has been previously stored in the storage part 46. When the customer IDs are in agreement with each other, it is determined that the extracted distribution signal is a distribution signal to the own station, and the extracted distribution signal is demodulated and stored in the storage part 46. Then, the distributed information is reproduced in an automatic manner or based on the instruction from the customer as start by the TV 42 (or another information reproduction device may be acceptable).

After repeating the above-described information distribution processing in the information distribution device 12, the information with the kind and field which an individual customer who has concluded a contract for information distribution with an information distribution agency desires is distributed to the individual customer at a time of the distribution that the customer desires, and the distributed information is configured to be reproduced with the information reproduction device which the individual customer has assigned.

Moreover, with regard to related information, other than the distribution information, which is distributed according to the wish of the customer, for example, when there is (distributed) the related information at reproduction of the distribution information, the presence of the related information is notified to the customer, and the related information may be configured to be reproduced on instruction by the customer for reproduction of the related information. Or, when it is not notified to the customer whether there is related information or not, and the related information is instructed to be reproduced by the customer, the related information maybe reproduced when there is the related information. But, if there is no related information, no presence may be notified to the customer. In addition, in the case of the distribution information, which has related information, the related information may be reproduced together with the distribution information. By reproducing the related information as described above, the usefulness and the entertaining performance of the information distribution service provided by the information distribution device 12 may be improved.

The information distribution service provided with the information distribution device 12 according to the present embodiment may be used for various kinds of applications by assigning the kind and the field, the time of distribution, the information display device, and so on of the distribution information according to the applications, and so on which the customer desires.

For example, if a thin image display device (the electronic paper 36, or an LCD) hung on the wall of a living room and so on is assigned as an information reproduction device; a landscape photograph or a still image of a painting is done as the kind and the field of the information to be distributed; and a suitable cycle is done as a time of distribution, the display device may be used as a parament with display contents which are automatically and periodically changed.

Furthermore, when a display layout is assigned so that the display surface of the image display device is divided into a plurality of display areas for example, as shown in FIG. 2; images to be displayed in each display area are assigned; and suitable cycles are assigned as time of distribution of each image, (for example, a talent image is distributed with a cycle of M days, and a landscape image is done with that of N hours, and so on), the images displayed in each display area are automatically changed at the assigned cycles, respectively. Accordingly, the image display device may be configured to have a function by which various kinds of pieces of information are displayed on the above device as an information display board.

In addition, when photographed image information is configured to be saved in (the HDD 14 of) the information distribution device 12 by uploading the photographed image information, which has been obtained after the customer himself photographed an object, to the information distribution device 12; the photographed image information is assigned as the information to be distributed; and, at the same time a relative, an acquaintance, or other persons is assigned as another distribution destination, the photographed image information is automatically distributed to the relative, the acquaintance, or the other persons as another distribution destination, and the photographed image may be displayed on the image display device of the relative, the acquaintance, and the other persons. Accordingly, the relative, the acquaintance, and the other persons may easily browse the photographed image.

Still further, when the photographed image information is assigned as an image to be distributed, and, at the same time, a date (for example, a date on which there is some event such as the photographing date, a memorial day, a public holiday) related with the photographed image is assigned as time of distribution, the customer may appreciate the images, which the customer himself has photographed, at appropriate time without complicated works such as a work by which album IDs are input, and operations in which the customer himself actively looks for desired images, as the assigned photographed image information is automatically distributed on the assigned date (date related with the photographed image).

Here, a photo-print of a desired image among images, which have been distributed to the customer, and displayed on the image display device, can be ordered by the customer in the information distribution system 10. The order of the photo-print by the customer may be realized, for example, from the PC 30, or the portable device 40 of the customer through the Internet 16, or it may be done by sending a message to the information distribution agency through another communication component such as the telephone. With regard to order for the photo-print by the customer, the order is not limited to the one by which the distributed image is simply printed on a photo-print, but it can be configured to assign a text or another image to be synthesized, or to assign the density, the shade, the gradation, and so on by adjustment.

When an order of a photo-print is received from the customer, the information distribution device 12 transmits information on the image which is the object of the order for the photo-print, information on the customer who places the order, information on the contents of the order, and so on to a photo-print processor 24, and ask the processor to execute the photo-print processing. The photo-print processor 24, who has received, through the Internet 16 and the computer 26, the information on the image, which is the object of the order for the photo-print, performs, according to the contents of the order represented by the received information, the photo-print processing using the received image information by the digital printing system 28. Then, the photo-print, which has made by the photo-print processing, is sent to a house, and so on, which is notified from the information distribution device 12, of the customer. Thereby, the result of the order for the photo-print by the customer is configured to be distributed to the customer.

And, the information distribution system 10 provides a service by which original data of the desired information, which the customer has assigned among pieces of information distributed to the customer, are transferred (downloaded) to the PC 30, and so on of the customer. In the case of photo-print processing according to the order by the customer for the photo-print, and of transferring (downloading) of original data according to the request of the customer, the settlement for the above cases may be made, for example, at claiming to the customer the rewards for the information distribution, by claiming the rewards which are obtained by adding the rewards for the order of the photo-print, or for the downloading to the rewards for the information distribution.

Here, in the first embodiment, the information related with photographed image information~to be distributed can be transmitted even when the information to be distributed is the photographed image information. For example, it may be configured that, when the customer uploads the photographed image information, the customer is requested to transmit the attribute information of the individual photographed information (the photographing date, the photographing place, the kind of the event (for example, travelling, athletic meeting, and so on) which is the motive leading the customer to photographing, and so on); the attribute information received from the customer is stored (saved), corresponding to the photographed image information; and the related information is added at distributing a specific piece of photographed image information after referring to the attribute information of the photographed image represented by the above photographed image information, and after retrieving the related information (for example, information like an encyclopedia, or information obtained by advertisements may be acceptable), based on the photographing date, photographing place, the kind of the event, and so on.

Moreover, it may be also configured that the field (a tendency of the tastes), and so on in which the customer is interested is analyzed for each customer, based on the attribute information stored corresponding to the photographed image information, and information in agreement with the tastes of the individual customers is distributed as the related information. Selecting the related information as described above corresponds to the selection component of the first aspect of the invention.

Furthermore, the above-described attribute information of the photographed image may be set, for example, by manual input of the customer, but it can be automatically set. That is, when the camera which the customer has used for photographing the object is a camera with a positioning function based on the Global Positioning System (OPS), and another function recording the photographing dates and the photographing places (and, the altitudes) together at photographing, the photographing date and the photographing place may be automatically determined by acquiring the above information. In addition, as the photographing direction angle on the horizontal plane and the photographing angle on the vertical plane may be recorded when the camera with the positioning function based on the GPS comprises a direction indicator as a direction finder, the object can be estimated by acquiring the above information, information on the photographing magnification factor, and so on, and by comparing it with a mapping data base, and so on. Still further, when events held throughout the country are stored as a data base, corresponding to information such as sites and dates of the events (the above data base may be provided in, for example, the information distribution device 12, or in a specific Web server connected to the Internet 16), it becomes possible by retrieving the data base based on the photographing date and the photographing place as a key to determine an event which had been held at a photographing place at photographing.

Moreover, there may be a configuration such that the photographing location and photographing direction (and the photographing date and time) are sent to the information distribution device 12 at the time of photographing (for example, when a release button is pressed by half) or at the time the photographed image is reproduced, by incorporating a function for wireless communication in a camera including a GPS function and a direction indicator for a direction finder, and the information distribution device 12 can be structured such that, when the photographing location and photographing direction (and the photographing date and time) are received, the object is estimated based on the received information, a search is conducted for information relating to the estimated object, and the information obtained by the search is distributed to the camera of the information transmission source. Accordingly, when the specific object is photographed by the customer and the image of the photographed specific object is reproduced and displayed, information relating to the specific object is immediately distributed from the information distribution device 12 and reproduced by the camera.

And, though the image processing which had been instructed to be executed by the customer has been executed in the above description only when it is set for “OTHER ATTRIBUTES” as the attribute information that execution of specific image processing such as addition of texts is instructed by the customer with regard to the image information to be distributed, the image processing is not limited to the above, but it may be configured that, even when, for example, addition of voice and comments, synthesis with other images, adjustments in the density, the shade, and the gradation, and so on are instructed from the customer who has seen the image reproduced and displayed on the image display device, image processing according to the instruction from the customer is performed, and image information after image processing may be distributed again.

Moreover, though the case in which information is always distributed at time of distribution designated has been described in the above description, the case is not limited to the above case. For example, with regard to a specific image displayed on the image display device, when information representing that it is an “IMPORTANT” image, or information representing that it is a “FAVORITE” image is received from the customer, the display period of the specific image may be extended (time for starting distribution of the next image is delayed), or the distribution information may be selected so that the distribution frequency of the specific image is increased when the subsequent distribution information after the next distribution information is selected.

Still further, with regard to the photographed image information of the customer, a case in which only the assigned photographed image information is distributed at a designated time of distribution has been described in the above, but the photographed image information is not limited to the above case. For example, it may be configured that, with regard to all pieces of the photographed image information which have been uploaded by the customers and saved, the distribution frequency for a predetermined period (for example, for one year) is counted, and the photographed image information which has not been distributed or has a comparatively low frequency may be distributed to the customer for a period during which no specific photographed image information is assigned to be distributed. Thereby, all pieces of the photographed image information, which have been uploaded by the customer and saved, may be distributed without causing distribution misses or extreme deviation of the distribution frequency.

And, entertaining elements such as games and quizzes may be added to the distributed information. For example, if, at distributing the image information, the image represented by the image information is divided into a plurality of areas, and, at the same time, one or more areas are set for the quiz area; image processing performing at least one of image synthesis, shape change, changes in the colors and the density is executed for the quiz areas; and the image information after the image processing is distributed, the customer referring to the image which has been distributed, reproduced and displayed may play a game such as a so-called error finding game. Moreover, pieces of game software which have the contents in agreement with the tastes of the customer, and can be executed in the PC 30, the portable device 40, and so on may be distributed. Thereby, the entertaining performance may be further improved by information distribution.

### The Second Embodiment

Then, the second embodiment of the invention will be described. Here, parts similar to those previously described with reference to the first embodiment are denoted by the same reference numbers, and the description will be eliminated.

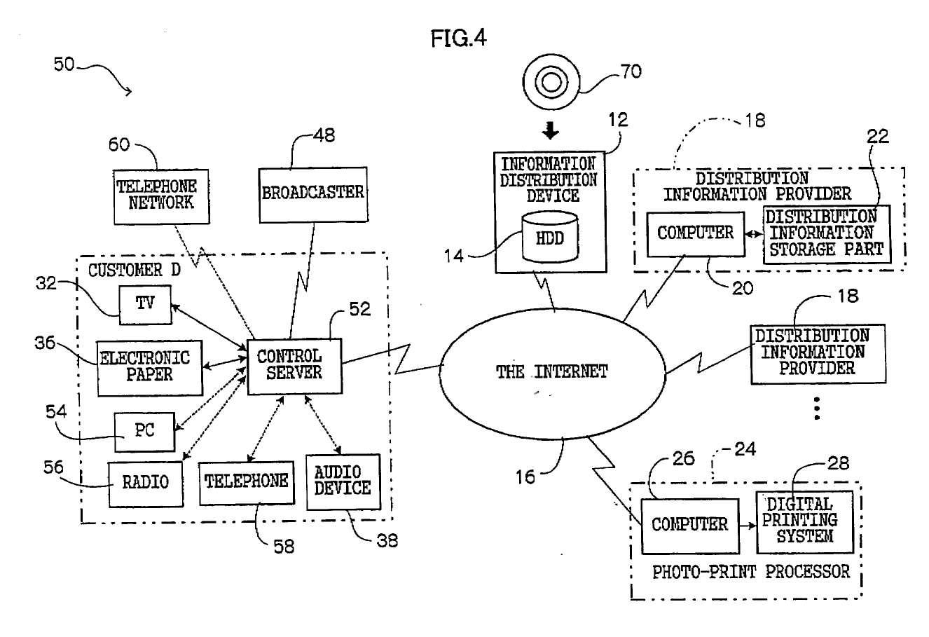

FIG. 4 shows an information distribution system 50 according to the present second embodiment. A customer (denoted by “CUSTOMER D” in FIG. 4) who uses a service provided by an information distribution device 12 of the information distribution system 50 owns a control server 52. The control server 52 has a function for recognizing the operations of information-processing devices in the house of the customer. Hereinafter, description will be given, assuming that an information-processing device is a TV 32.

Though an interface between a control server 52 and a TV 32 is considered to have some modes, there may be adopted an interface by which a program (moving image) of a view channel assigned by the customer is displayed on the TV 32, for example, by a configuration in which instruction for TV 32 from the customer (on/off of the power supply, assignment of a view channel, and so on) is conveyed from the TV 32 to the control server 52; a TV broadcasting signal of a channel assigned by the customer, among TV broadcasting signals of a plurality of channels which a broadcaster 48 broadcasts, is received; and the control server 52 outputs the received signal to the TV 32. And, an interface by which the TV 32 receives the TV broadcasting signal may be adopted, though the instruction from the customer to the TV 32 is conveyed from the TV 32 to the control server 52. By adopting the above-described interface, the control server 52 may recognize the operations of the TV 32 (the start/end time for viewing, the viewing channel, and so on).

Moreover, the control server 52 is connected to the Internet 16. In the information distribution system 50 according to the present second embodiment, the field and the contents of the TV program, which the customer is viewing, are determined by at least one of the control server 52 and the information distribution device 12, based on the operations, which the control server 52 recognizes, of the TV 32.

The field, and the contents of the TV program are determined, for example, by a configuration in which: a TV program data base in which the fields and the contents of the programs which the broadcasters are broadcasting have been stored for each channel and each time zone has been stored in the HDD 14 of the information distribution device 12; the control server 52 simply notifies the recognized operations of the TV 32 (the start/end time for viewing, the viewing channel, and so on) to the information distribution device 12 though the Internet 16; and the information distribution device 12 retrieves the TV program data base based on the notified information as a key to determine the field and the contents of the TV program. Furthermore, the determination may be realized by a configuration, instead of retrieving the TV program data base, in which: the information distribution device 12 transmits the notified information to the broadcaster 48, and inquires to the broadcaster 48 about the field and the contents of the TV program which the customer is viewing.

In addition, the field and the contents of the TV program may be determined, for example, as follows: the broadcaster 48 broadcasts the program information representing the field and the contents of the program under superimposing the program information on the TV broadcasting signal; the TV 32 or the control server 52 extracts the program information from the TV broadcasting signal; the control server 52 refers to the contents of the program information for the determination; or the control server 52 transmits the program information to the information distribution device 12 through the Internet 16; and the information distribution device 12 refers to the contents of the received program information for the determination.

Still further, after the voice of the TV program which the customer is viewing is recognized by the control server 52, the control server 52 may automatically determine the field and the contents of the TV program, based on the field and the meaning of the words, which frequently appear, or the frequency of the words of a specific field. Moreover, it may be configured that the information distribution device 12 receives the signal of the TV program which the customer is viewing, based on the operations, which has been notified from control server 52, of the TV 32, and the information distribution device 12 executes the above-described processing.

When the field and the contents of the TV program which the customer is viewing are determined, the information distribution device 12 retrieves, in a similar manner to that of the information distribution processing (steps 116 to 122 in FIG. 3B) which has been described in the first embodiment, information related with the field and the contents of the TV program which the customer is viewing (the processing corresponds to the selection component of the first aspect of the invention); and the extracted related-information is distributed through the Internet 16 to the control server 52 which the customer has. The control server 52 distributes again the related information, which has been distributed from the information distribution device 12 to an information reproduction device suitable for distribution of the related information (for example, to an image display device such as the electronic paper 36 connected to the control server 52 if the related information is image information).

Thereby, as the information related with the field and the contents of the TV program which the customer is viewing is reproduced with the information reproduction device to which the related information is distributed again, the customer may also enjoy the related information reproduced with the information reproduction device, while viewing the TV program which is appearing on the TV 32. Here, the related information may be also configured to be reproduced with the TV 32 by distributing again the distributed related-information to the TV 32 (for example, if the related information is image information, the related information is displayed in a small area provided in the display surface of the TV 32, or during broadcasting a commercial message by television, and so on).

Moreover, in the second embodiment, the distributed related-information may be the photographed image information, which has been uploaded by the customer of the distribution destination, and saved in the HDD 14. If, as one example, photographed image information representing a scene in which the customer have previously visited a specific place is configured to be distributed, while the customer is viewing the TV program in which the specific place is taken up as a theme, the usefulness and the entertaining performance, for the customer, of information distribution may be improved, for example, memories at visiting a specific place come back by referring to the reproduced photographed image.

Furthermore, it may be configured, in the second embodiment, that the fields and the contents of the TV programs which the customers have viewed are accumulated and stored as information; the fields (tendencies of the tastes) in which the customers are interested are analyzed based on the information which has been accumulated and stored; and information in agreement with the preferences of the customers are distributed as the related information. Selecting the related information as described above corresponds to the selection component of the first aspect.

Still further, it may be configured, in the second embodiment, that, for example, when the TV program which the customer is viewing has the contents that a specific commodity is introduced, or when a commercial message for the specific commodity is appearing on the TV 32, an advertisement of a shop, which is located near the house of the customer, and is handling the specific commodity is distributed. And, it may be also identified, by information superimposed on the TV broadcasting signal, voice recognition, or inquiring to a broadcaster, whether the specific commodity is appearing on the TV 32.

In addition, though “the field and the contents of the TV program which the customer is viewing with the TV 32” has been described in the second embodiment as one example of “contents of information which the customer has been acquired through another communication component” of the first aspect of the invention, “contents of information which has been acquired or sent through another communication component” may be, for example, the field, and the contents of the information which the customer has received or sent through a PC 54 (refer to FIG. 4) and the Internet 16; the field, and the contents of the radio program which the customer is receiving and listening with a radio 56 (refer to FIG. 4); and the contents (e.g., a person or proper name that comes up in conversation) at a time when the customer is calling a person on the telephone through a telephone 58 and a telephone network 60 (refer to FIG. 4). And, for example, the contents (for example, the field and the name of the music, the names of the players, and so on) of voice which the customer is reproducing with the audio device 38 are listed as “contents of information which the customer has selected for reproduction” of the first aspect of the invention. It is obvious, in the second embodiment, that the related information may be configured to be distributed after selection based on the information representing the contents as described above.

Although description has been given in the first and second embodiments of a case where information is distributed at a designated distribution time, the invention is not limited thereto. The invention can also be configured such that the actions of the equipment owned by the customer are detected by the control server 52 and information relating to altered actions or the like are selected and distributed to the customer at the time the actions or the like of the equipment have been altered. Specifically, the invention can be configured so that the reception or placement of a call by the telephone 58 (or a cellular phone) is detected, the party with whom the customer is talking is identified when a call is received or placed, and information (e.g., photographs taken when the customer and the party with whom the customer is talking were on vacation together) relating to the identified party is selected and distributed. The invention may also be configured such that the reception or transmission of an e-mail by the PC 54 (or a cellular phone) is detected, the party from or to whom the PC 54 has received or sent the e-mail is identified when an e-mail has been received or sent, and information relating to the identified party is selected and distributed. The invention can also be configured such that a video camera for photographing visitors to the customer's home is set up, whether or not the doorbell at the entranceway has been rung by the visitor is detected, and when the doorbell at the entranceway has been rung by the visitor, the visitor to the customer's home is identified on the basis of a moving image obtained by the photographing video camera, and information relating to the identified visitor is selected and distributed. Additionally, the invention may be configured such that whether cooking appliances of the customer are running or not is detected, and information relating to when the cooking appliances are running or not running (e.g., information relating to cooking or information relating to the operation of the cooking appliances) is selected and distributed. Moreover, the invention can be configured such that whether the customer's electrical appliances are running or not is detected, and information relating to when the electrical appliances are running or not running (e.g., information introducing examples of using the relevant electrical appliance or information representing advertisements for new products) is selected and distributed. The aforementioned electrical appliances may be games and karaoke machines.

The invention can also be configured such that, in place of detecting the actions of equipment owned by the customer, the use of media such as books, CDs, video tapes, DVDs and the like owned by the customer can be detected, and when a specific medium is used by the customer, information relating to the specific medium used is selected and distributed. Detection of the media used by the customer can be realized by attaching to each medium an IC tag, in which information representing the content and type of the respective media is recorded. IC tag sensors can be placed in use locations into which the respective media are disposed at the time they are used (e.g., if the medium is a CD, the location would be a CD player, and if the medium is a DVD, the location would be a DVD player) or in storage locations where the respective media are stored when not in use. The IC tag sensors are respectively connected to the control server 52. When the IC tag sensor detects that a specific medium attached with an IC tag has been placed in a use location or removed from a storage location, the information recorded in the IC tag attached to that specific medium is read by the IC tag sensor. It is possible to use optional equipment to reproduce the distributed information, such as a display disposed on a wristwatch owned by the customer. Using the above technology, it is also possible for characters and illustrations representing the content of a specific book to be displayed on a display of a wristwatch worn by the customer, when the customer removes by hand a specific book from a bookshelf acting as a storage location for books in a library or home of the customer.

Moreover, though, according to the first and second embodiments, image processing for converting the information acquired for distributing to the customer into the information suitable for reproduction and display with the information reproduction device to be used for reproduction of the information has been performed in the information distribution device 12, the device for the above image processing is not limited to the above-described device. For example, when the customer has the information processing device such as the PC 30, and the control servers 52, the above-described image processing may be configured to be performed with the above information processing device.

Furthermore, the information reproduction device is not limited to the devices shown in FIG. 1 and FIG. 4. For example, a stereoscopic television provided with a specially designed lens surface (for example, a lenticular plate) for stereoscopic display may be used as an image display device for reproducing and displaying images. When the above-described stereoscopic television is set for “INFORMATION REPRODUCTION DEVICE TO BE USED”, image processing for stereoscopic display of images with the stereoscopic television may be performed for the distribution information by the information distribution device 12 (or, the PC 30 of the customer).

In addition, it may be configured that, when the customer makes some adjustments (for example, adjustment of the density, the shade, the gradation, and so on for images which are displayed on the image display device) for information which has been distributed from the information distribution device 12, and reproduced with the information reproduction device, the information reproduction device is provided with a function for transmitting adjustment information to the information distribution device 12, assuming that the adjustments in the above case are the adjustment information; and the information distribution device 12 performs, for the information which has been acquired for distribution to the customer, the image processing corresponding to the adjustments which the customer has done, based on the received information on the adjustments. Thereby, the customer is not required at each reproduction to make similar adjustments for the reproduced information.

Although description has been given in the first and second embodiments of a case where the information distribution device 12 distributes information to plural customers, the invention is not limited thereto. The invention may also be configured such that information is distributed only to a single customer, by installing the program recorded on the recording medium pertaining to the invention in a computer (e.g., a home information server or the like set up for the purpose of accumulating a large amount of information in a home digital network environment) disposed in the home or the like of that single customer and having the computer function as the information distribution device pertaining to the invention.

In this aspect also, the computer functioning as the information distribution device can, similar to the control server 52 described in the second embodiment, determine the content and field of a television program that the customer is watching or a television program that the customer has set to be recorded (the determination of the content and field of the television program that is set to be recorded may be made at any of the time the program is set to be recorded, the time of recording, or the time the recorded television program is played back), search the Internet 16 for information relating to the content and field of the television program that the customer is watching (the genre of the information to be searched for can be preregistered and searched for only when the content and field of the determined television program matches the registered genre), and display for the customer at a predetermined time the related information extracted by the search (if it is information relating to a television program that the customer is watching, then the information can be immediately displayed for the customer, and if it is information relating to a television program that the customer has set to be recorded, then the information can be temporarily stored in a storage device and displayed for the customer when the recorded television program is played back).

The television 32 can be used to as an information playback device for displaying the related information, so that the related information is displayed for the customer by displaying the related information within a relatively small area disposed in the screen of the television 32. Alternatively, an information playback device such as the electronic paper 36 or the like can also be used in place of the television 32. When a display comprising a LCD or the like is disposed in a remote controller of the television 32, the remote controller can be used as the information playback device so that the related information is played back for the customer by the related information being sent to the remote controller and displayed on the display.

Furthermore, because the computer set up in the customer's home or the like functions as the information distribution device of the present invention, the information distribution device can also be configured so that only information stored in the storage component is distributed, in an embodiment in which information (e.g., information that is simultaneously stored in the storage component by installing in a computer the program pertaining to the present invention, or information that is uploaded by the customer to the information distribution device and stored in the storage component) is distributed only to a customer in whose home or the like a computer functioning as the information distribution device is set up. In this case, because the election and distribution of information is conducted in a closed environment that is within the home of the customer, it becomes unnecessary for the information distribution device to be connected to the outside via the Internet 16 or the like. In the aforementioned embodiment, the owner of the information distribution device is the same person (i.e., the customer) as the recipient of the information that is distributed, but the recipient of the information that is distributed in this embodiment is also included in the customer pertaining to the present invention.

What is claimed in;

1. An information distribution device comprising:
a selection component for selecting contents information to be distributed to a customer, based on information obtained from the customer; and
a distribution component for distributing the contents information selected by the selection component to the customer through a predetermined communication component.

2. The information distribution device of claim 1, wherein
the selection component selects for each customer the contents information to be distributed to the customer, based on information obtained from each customer, and
the distribution component distributes the contents information selected by the selection component to each customer.

3. The information distribution device of claim 1, wherein the contents information to be distributed to the customer includes at least one of a still image, a motion image, audio, text, and a program.

4. The information distribution device of claim 1 further comprising a storage component for storing contents information that can be distributed to the customer,
wherein the selection component selects the contents information to be distributed from the contents information stored in the storage component.

5. The information distribution device of claim 4, wherein
contents information supplied from the customer is stored in the storage component, and
the distribution component distributes, as the contents information to be distributed, the contents information supplied from a specific customer and selected by the selection component to at least one of the specific customer and a distribution destination designated by the specific customer.

6. The information distribution device of claim 1, wherein
a field or kind of contents information that the customer desires to be distributed, and at least one of a time and cycle of the contents information distribution, are designated by the customer in advance, and
the selection component selects the contents information to be distributed to the customer so that the contents information is distributed to the customer according to the designation from the customer, based on information representing the content of the designation obtained from the customer.

7. The information distribution device of claim 6, wherein
fields or kinds of plural contents information that the customer desires to be distributed are designated by the customer in advance, and at least one of times and cycles of the contents information distribution are designated for each field or each kind by the customer in advance,
the selection component selects for each field or each kind the contents information to be distributed according to the distribution times or cycles designated in advance, and
the distribution component distributes the contents information selected by the selection component to the customer for each field or each kind.

8. The information distribution device of claim 1, wherein the distribution component distributes plural image information after editing the plural image information so that a plurality of images represented by the plural image information selected by the selection component is displayed, as the contents information to be distributed to the customer, on a display component of the customer in a display layout designated in advance by the customer of a distribution destination.

9. The information distribution device of claim 1, wherein the distribution component distributes, as the contents information to be distributed to the customer, image information selected by the selection component after effecting image processing according to at least one of image information attributes, a designation from the customer of a distribution destination, and a configuration of a display component for displaying images represented by the image information.

10. The information distribution device of claim 1, wherein the selection component also selects contents information related to the contents information selected as the contents information to be distributed.

11. The information distribution device of claim 1, wherein the selection component selects contents information related to the content of the contents information that has been obtained, sent, or selected by the customer as the contents information to be distributed, based on at least one of information that has been obtained from the customer and represents the content of contents information the customer obtains or sends through another communication component and information representing the content of contents information the customer has selected for reproduction.

12. The information distribution device of claim 10, wherein the selection component determines a tendency of customer tastes from the information obtained from the customer and selects contents information that matches the tendency of the customer tastes as the related contents information.

13. The information distribution device of claim 1, wherein the distribution component distributes the contents information through a communication line network or television broadcasting as the predetermined communication component.

14. The information distribution device of claim 13, wherein the distribution component adds to the distribution information a customer ID that is used for identifying a contents information distribution destination when the contents information is distributed through television broadcasting.

15. An information distribution method comprising the steps of:
(a) selecting contents information to be distributed to a customer, based on information obtained from the customer; and
(b) distributing the selected contents information to the customer through a predetermined communication component.

16. The information distribution method of claim 15, further comprising the step of
(c) storing contents information that can be distributed to the customer,
wherein, in step (a), the contents information to be distributed is selected from the contents information stored in step (c).

17. The information distribution method of claim 16, wherein
in step (c), contents information supplied from the customer is stored, and
in step (b), contents information supplied from a specific customer and selected in step (b) is distributed as the contents information to be distributed to at least one of the specific customer and a distribution destination designated by the specific customer.

18. The information distribution method of claim 15, wherein
a field or kind of contents information that the customer desires to be distributed, and at least one of a time and cycle of the contents information distribution, are designated by the customer in advance, and
in step (b), contents information to be distributed to the customer is selected so that the contents information is distributed to the customer according to the designation from the customer, based on information representing the content of the designation obtained from the customer.

19. The information distribution method of claim 18, wherein
fields or kinds of plural contents information that the customer desires to be distributed are designated by the customer in advance, and at least one of the times and cycles of the contents information distribution are designated for each field or each kind by the customer in advance,
in step (b), the contents information to be distributed is selected for each field or each kind according to a time or cycle of the contents information distribution designated in advance, and
the contents information selected in step (b) is distributed to the customer for each field or each kind.

20. A recording medium in which a program executed by a computer is recorded, the program comprising the steps of:
selecting contents information to be distributed to a customer, based on information obtained from the customer; and
distributing the selected contents information to the customer through a predetermined communication component.
